(19) United States
(12) Patent Application Publication
(10) Pub. No.: US 2010/0241863 A1
(43) Pub. Date: Sep. 23, 2010

(54) DEVICE FOR REPRODUCING DIGITAL CONTENT, SECURE ELECTRONIC ENTITY, SYSTEM COMPRISING SAID ELEMENTS AND METHOD FOR REPRODUCING DIGITAL CONTENT

(75) Inventors: Christophe Giraud, Pessac (FR); Jean-Bernard Fischer, Le Kremlin Bicetre (FR); Caroline Fontaine, Rennes (FR); Abdellatif Benjelloun-Touimi, Lannon (FR); Michel Milhau, Cairon (FR); Benoît Prady, Paris (FR)

Correspondence Address: YOUNG & THOMPSON, 209 Madison Street, Suite 500, Alexandria, VA, 22314, US

(73) Assignee: FRANCE TELECOM, Paris (FR)

(21) Appl. No.: 12/294,992

(22) PCT Filed: Mar. 27, 2007
(86) PCT No.: PCT/FR2007/000525

§ 371 Date: Sep. 29, 2008

(30) Foreign Application Priority Data
Mar. 29, 2006 (FR) 0651089

(51) Int. Cl. H04L 29/06; H04L 12/22

(52) U.S. Cl. 713/176; 726/26

(57) ABSTRACT

The invention concerns a method for reproducing digital content including the following steps: receiving (E222) an identifier (Id′) of the digital content from a secure electronic entity; extracting (E226) a digital watermark of the digital content; controlling (E232) the reproduction of the content based on a comparison between the extracted watermark and the identifier. The invention concerns a reproducing device, an electronic entity and related systems.

The invention concerns a device for reproducing digital contents, a secure electronic entity, a system comprising said elements and a method for reproducing digital contents.

Conditional access systems are used to make a digital content (for example a multimedia content, an audio content, a video content, an image or a software content) accessible only to authorized users (for example users who have purchased the right to reproduce the content).

One such system that is commonly used usually is encrypts the digital content by means of an encryption system that makes the content accessible only to persons holding a cryptography key, for example stored in a secure electronic entity such as a smart card.

As reported, for example, in the paper “Beyond Cryptographic Conditional Access” by David M. Golschlag and David W. Kravitz in Proceedings of 1st Workshop on Smartcard Technology, Chicago, Ill., USA, 10-11 May 1999, in these solutions fraudulent access to the data contained in a single smart card is sufficient to compromise the security of the entire system and, moreover, once decrypted illicitly, the digital content can be copied and reproduced without limit.

The above paper therefore proposes to task the reproduction device with verifying if reproduction of the digital content is authorized. To this end it is proposed that, if a visible digital watermark is detected in the content, the content is reproduced only if a certificate is present in a smart card matched to the reproduction device. The smart card is therefore used as a licensing authority to authorize reproduction of the content bearing the watermark.

This solution relies in particular on the difficulty of eliminating the digital watermark without damaging the content and of mass producing pirate reproduction devices that would bypass the protection system.

The fact that the smart cards and the reproduction devices are matched can nevertheless prove inconvenient to the user, who naturally wishes to be able to reproduce (for example to view or listen to) the digital content to which they have purchased rights on any reproduction device, and not to be limited to one particular device.

It has also been proposed, in the patent application JP 2000-184172, to store in a smart card rights purchased by a user for different types of digital content and to debit credits stored in the card when reproducing a content of a particular type (or style) by means of a style indicator stored in the card, against the remaining credit for that style, and carried by a digital watermark buried in the content to be reproduced.

However, this solution does not make reproduction of the digital content conditional on holding rights specifically associated therewith.

In this context, the invention proposes a device for reproducing a digital content characterized by means for receiving an identifier of the digital content from a secure electronic entity, means for extracting a digital watermark from the content, and means for controlling the reproduction of the content as a function of a comparison based on the extracted watermark and the identifier.

Reproduction of the content can therefore be conditional on the watermark that it contains matching the identifier stored in the secure electronic entity.

For example, the means for receiving the identifier of the digital content comprise means for setting up a secure call with the secure electronic entity, which prevents the identifier being made accessible to malicious persons.

For example, the means for setting up a secure call comprise means for decrypting the identifier of the digital content: encryption is an effective security measure that is relatively simple to implement.

In practice, the means for setting up a secure call can use a session key to encrypt the secure call.

Furthermore, the reproduction device can comprise means for decrypting an encrypted version of the digital content received from the secure electronic entity: this prevents easy access to the digital content during its transmission, for example from the electronic entity to the reproduction device after a first decryption.

The means for decrypting said encrypted version can in practice use a session key.

The device can include means for exchanging the session key in encrypted form with the secure electronic entity, and possibly means for generating the session key. In one practical embodiment, the means for exchanging the session key can be configured to be activated each time the device is switched on.

The reproduction device can equally include means for sending the encrypted digital content to the secure electronic unit, for example as it receives it from a remote server for its decryption in the secure electronic entity.

Decompression means, for example decompression software, can be provided to obtain the digital content from a compressed version of the digital content.

In an embodiment this is of particular benefit from the security point of view, an integrated circuit includes means for receiving the identifier, means for extracting the watermark and the control means.

The means for controlling reproduction of the content are adapted, for example, to command reproduction of the content in the event of equality between data obtained from the extracted watermark and data obtained from the identifier. Said data can then be the extracted watermark and the identifier, respectively.

The watermark is generally an imperceptible watermark, so that hackers cannot access it.

The secure electronic entity is a removable portable entity, for example, such as a smart card or a USB protocol information medium, generally referred to as a USB key.

In particular, it can be a secure microcontroller card conforming to the 1507816 standard.

The digital content is a perceptible content, for example an audio content, in which case sound reproduction is means can be controlled by said control means and the integrated circuit can include a digital-to-analog converter, or a video content, in which case the reproduction device can include a screen and means for displaying the content on the screen controlled by said control means.

The device can further include means for receiving data representing the digital content from a remote server; the representative data can then be decrypted by means of a key stored in the secure electronic entity.

The content can furthermore be received over a communication network, for example a wireless or cable network. Alternatively, it can be downloaded directly from an information medium such as an optical disc or a semiconductor memory.

There can additionally be provided means for receiving the identifier of a remote server and means for sending the identifier to the secure electronic entity. The identifier is received in encrypted form, for example, to be decrypted by means of a key, possibly a temporary key, stored in the secure electronic entity.

In one embodiment the reproduction device is a mobile telephone. The reproduction device can then receive the digital content and/or the identifier over the associated mobile telephone network. In this case, the secure electronic entity can be a smart card for managing the right of the mobile telephone to access a telecommunication network. Alternatively, the reproduction device can be a personal computer, for example, or a digital television decoder.

According to the invention, the identifier is generally identical for all copies of the same content.

Likewise, the invention also proposes a secure electronic entity adapted to cooperate with a device for reproducing a digital content, characterized by means for sending an identifier of the digital content to the reproduction device.

The means for sending the identifier of the digital content can comprise means for setting up a secure call with the reproduction device and which can incorporate means for encrypting the identifier of the digital content.

The secure electronic entity can also have features corresponding to those referred to hereinabove with reference to the reproduction device.

In particular, means can be provided for encrypting the digital content for transmission to the reproduction device, possibly means adapted to use a session key.

similarly, the electronic entity can include means for decrypting an encrypted version of the digital content received from the reproduction device, possibly by means of a cryptography key, possibly a temporary key and/or a key shared with a remote server.

The invention further proposes a system comprising a device and an electronic entity both as described above.

The invention finally proposes a method of reproducing a digital content characterized by the following steps:
receiving an identifier of the digital content from a secure electronic entity;
extracting a digital watermark from the content;
commanding the reproduction of the content as a function of a comparison based on the extracted watermark and the identifier.

In accordance with features already referred to, reception of the identifier of the digital content can utilize a secure call with the secure electronic entity and/or the secure call uses encryption by means of a session key.

There can also be provision for the following steps, possibly in combination:
receiving the content from the secure electronic entity by means of a secure call, the secure call using encryption by means of a session key;
sending encrypted data representative of the digital content to the secure electronic entity and decrypting the encrypted data in the secure electronic entity;
secure transmission of the identifier and a key for decrypting the content from a remote server to the secure electronic entity;
reproducing the content in the absence of detection of a watermark.

Other features and advantages of the invention emerge in the light of the following description with reference to the appended drawings in which:

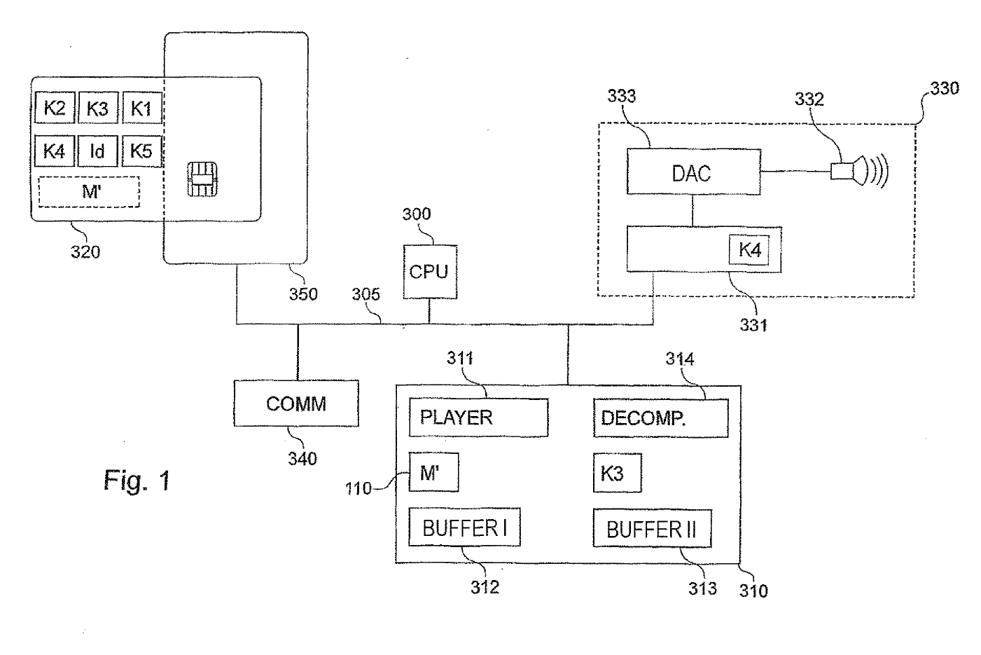

FIG. 1 represents a reproduction device conforming to the teachings of the invention;

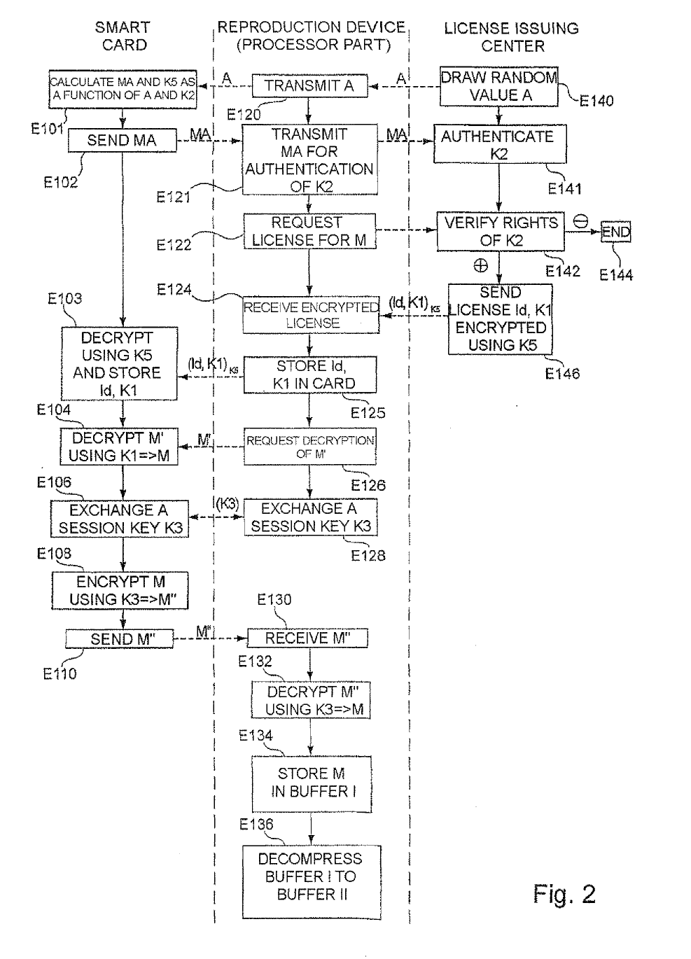

FIG. 2 represents a flowchart illustrating the operation of the device from FIG. 1 and interaction with other elements;

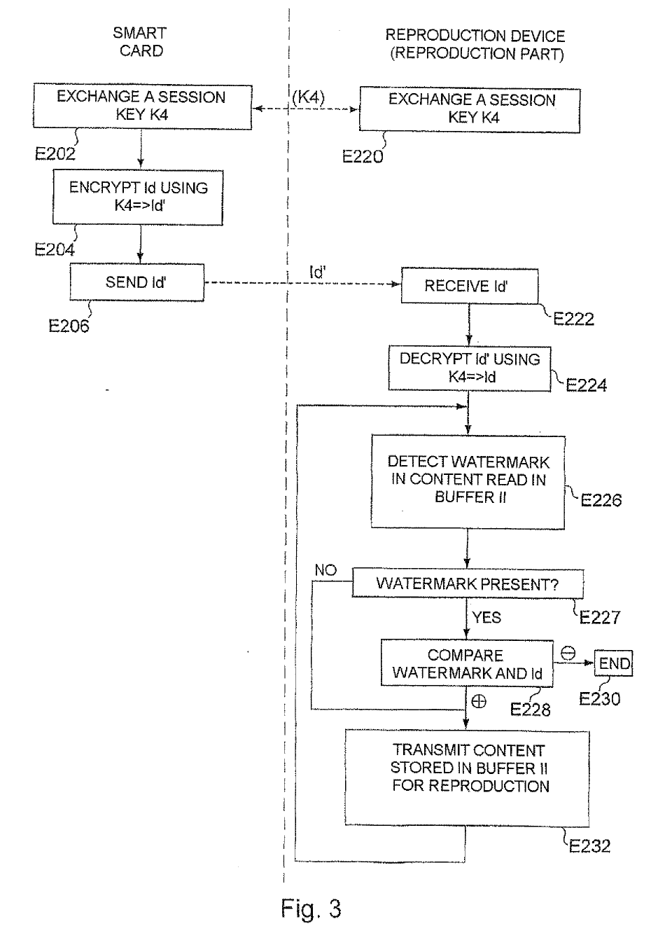

FIG. 3 represents a flowchart of the same type as FIG. 2 illustrating other portions of the operation of the device from FIG. 1;

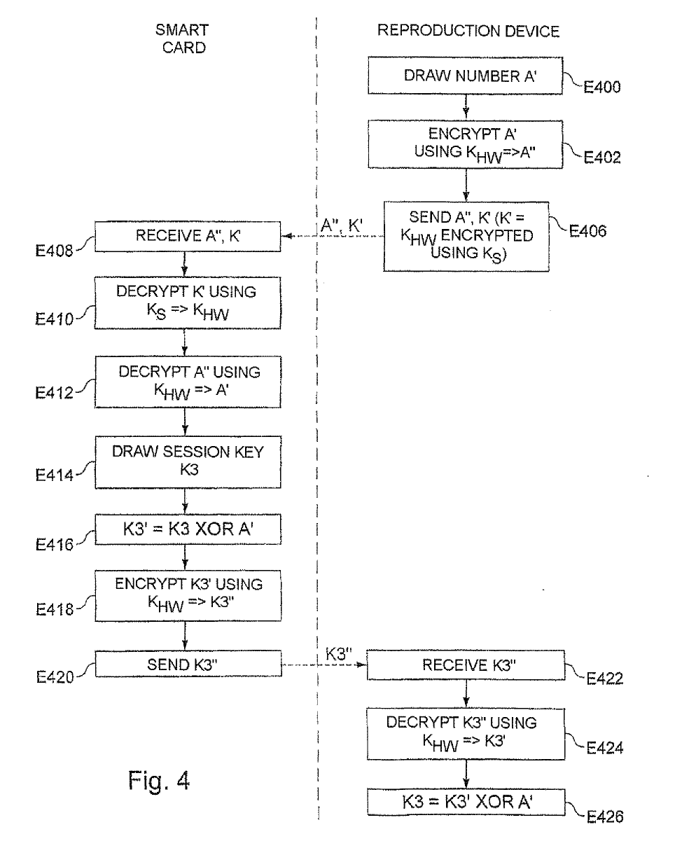

FIG. 4 represents one possible way of exchanging a session key.

FIG. 1 represents the main elements of a device for reproducing a digital content, here of audio type. In the example shown and described hereinafter, the reproduction device is a mobile telephone, here a cellular mobile telephone. The teachings of the invention naturally apply to devices of other types, for example portable digital players or personal computers configured to constitute a reproduction device.

Moreover, the invention applies with particular benefit to audio digital contents, as described here, but can also be used for contents of other types, in particular video contents and software contents.

The FIG. 1 reproduction device includes a microprocessor-based central processor unit (CPU) 300.

The central processor unit 300 is connected by a data bus 305 to other electronic circuits that form the reproduction device, in particular a memory 310, a smart card reader 350, a communication circuit 340 and an audio reproduction circuit 330.

The memory 310 stores programs executed by the central processor unit 300 (in particular a program for managing reproduction of the content 311 and a decompression program 314).

The memory 310 also stores data such as a compressed and encrypted digital content M′ (110) and key data K3. This data is stored and exchanged with the other circuits of the device in the manner explained hereinafter.

The memory 310 also includes a first buffer area 312 (BUFFER I in the figures) and a second buffer memory area 313 (BUFFER II in the figures).

Although FIG. 1 shows the memory 310 in the form of a single block, physically different memories could naturally be provided, possibly of different types, for storing the elements that have just been referred to. In particular a rewritable (for example EEPROM) memory could be used to store the programs 311, 314 and a random access memory (to which access is faster) to form the buffer memory areas 312, 313.

The example of a reproduction device envisaged here also includes, as already indicated, a communication circuit 340 for exchanging data with other electronic devices, for example by electromagnetic telecommunication means. As already mentioned, in the example described here, the reproduction device is a cellular telephone and the data exchanged by means of the communication circuit 340 can therefore also relate to calls, notably voice calls, provided by the cellular telephone.

The smart card reader 350, connected to the central processor unit 300 by the bus 305, contains a smart card 320 when it is operating and thus enables exchange of data between the central unit 300 and the smart card 320.

The smart card 320 includes means for storing data such as key data K2, K3, K4, identifier data Id and the compressed and encrypted digital content M′ (or at least part of it), all represented in a simplified manner by blocks on the smart card 320.

The smart card 320 can also, although not necessarily, contain data relating to rights of communication over a cellular network, in particular for the voice calls referred to above.

The audio reproduction circuit 330 includes a security circuit 331 connected to the other circuits by the bus 305.

The security circuit 331 feeds a digital-to-analog converter 333 which controls the sound reproduction means 332, for example a loudspeaker or earpiece, with digital data in the manner described later.

There is described hereinafter by way of example the reproduction of a digital content 110 stored in encrypted and compressed form in the memory 310 of the reproduction device. The encryption is of the symmetrical key type, for example (such as that using the DES algorithm). Alternatively, it can be asymmetrical key encryption, for example using the RSA algorithm. The compression used is for example MPEG-4 AAC compression; alternatively it can be MPEG-4 HE-ACC compression or 3GPP Extended AMR WE (AMR-WB+) compression, etc.

It is considered here that the compressed and encrypted digital content M′ stored in the form of a file was supplied to the reproduction device by a content server, for example by means of the communication circuit 340. The file M′ could alternatively have been recovered from the content server (or some other content server) via a personal computer, and then transferred into the reproduction device (here the cellular telephone), for example by means of a cable or by wireless data communication means.

The file M′ could instead be stored directly in the smart card (in which case it would not be necessary to send it to the card in the step E126 described below).

Once decrypted and decompressed, the digital content corresponding to the file M′ also carries an imperceptible digital watermark that is linked to an identifier Id of the content and used as explained later.

FIGS. 2 and 3 represent the main steps executed in the various elements of the reproduction device when the user requests reproduction of the content represented by the file M′, namely in practice to listen to the tune formed by that file.

FIG. 2 represents the steps executed within the smart card (steps E101 to E110), in the reproduction device itself (in particular by means of the “Player” program 311, steps E120 to 2136), and at a license issuing center (2140 to 2146).

The process begins with authentication of the holder of the smart card with the license issuing center. This kind of authentication procedure including generation of a temporary key (K5 hereinafter) is described in patent application FR 2 837 336, for example.

In practice, the license issuing center generates a random value A in a step 2140. By random value is meant a value that cannot be predicted from the outside, sometimes referred to as a pseudo-random value. The random value A is transmitted to the smart card 320 via the reproduction device (and in particular the communication circuit 340) in a step 2120.

On the basis of the random value A, the smart card 320 calculates in a step 2101 and using the cryptography key K2 that it is holding an authentication word MA and a temporary key K5 used afterwards for communication between the license issuing center and the smart card 320. The authentication word MA and the temporary key K5 are calculated as proposed in the previously mentioned patent application FR 2 837 336, for example.

The smart card 320 then sends the authentication word MA in a step 2102 by means of the communication circuit 340 (step 2121) to the license issuing center which can therefore in a step 2141 verify that the smart card 320, which has been able to determine the authentication word MA from the random value A, was indeed holding the cryptography key K2. The license issuing center thus authenticates the smart card 320.

Once the authentication phase has ended, the reproduction device can request in a step 2122 an electronic license for the tune M from the license issuing center, for example by sending the center a code designating the tune M.

The license issuing center then (step E142) verifies the rights to the tune M associated with the previously authenticated smart card.

If no license purchase in respect of the tune M is stored in the license issuing center, the process is terminated (step E144) and the tune M is not reproduced (although it is stored in the memory 310 in the form of a compressed and encrypted file M′).

On the other hand, if the holder of the smart card has obtained reproduction rights (for example by paying a license fee for the tune M), the license issuing center in a step E146 sends the electronic license formed of an identifier Id associated with the tube M and a key K1, is encrypted by means of the temporary key K5 obtained during authentication, together with the right granted to the holder of the smart card to use the digital content purchased.

On reception of the encrypted license including Id, K1 via the communication circuit 340 (step E124), the central processor unit 300 commands storage thereof in the smart card 320 (step E125).

The smart card 320 then stores the electronic license Id, K1 in a step E103, following decryption by means of the key K5.

The smart card 320 holding information supplied by the license issuing center, it will be possible to decrypt and decompress the content M′ in the steps being explained at the moment.

Execution of the program 311 by the central processor unit 300 then generates (step E126) a request for decryption of the compressed and encrypted content M′ sent to the smart card 320.

On reception of that instruction, the smart card 320 then proceeds in a step E104 to decrypt the content M′ by means of the key K1 received beforehand as explained above. To this end, the central processor unit 300 sends the smart card 320 the content M′ in encrypted and compressed form.

The smart card 320 stores temporarily the compressed and encrypted content M′ (as indicated by a dashed line in FIG. 1) and decrypts the encrypted content M′ to yield a compressed (and therefore decrypted) content M. In order not to compromise the security of the system, the compressed digital content M is not retransmitted directly by the smart card 320, but is encrypted by means of a session key K3 as described later.

In steps E106 and E128 (respectively for the smart card 320 and the reproduction device itself), the central processor unit 300 and the smart card 320 exchange a session key K3, for example by the method described later with reference to FIG. 4.

This exchange can moreover take place before this, for example each time that the reproduction device is switched on.

The smart card then, in a step 2108, encrypts the compressed digital content M using the session key K3 previously exchanged and thus generates a new encrypted and compressed version M″ of the digital content that is sent in a step E110 to the central processor unit 300. Decrypting the whole of the content M in a single step is described above. In practice, decrypting part of the content M in the card can be envisaged, as it enables the use of a smart card in which the memory dedicated to decryption has a size less than the size of the encrypted content M′, for example as described in the patent application FR 2 834 154.

On reception of the new version M″ (step 2130), the reproduction device decrypts it using the session key K3 in order to retrieve the compressed digital content M (step E132).

The compressed digital content M is then stored in the first buffer memory area 312 in a step E134. In a step E136, the decompression program 314 decompresses the content of the first buffer memory area 312 into the second buffer memory area 313.

It will be noted that, thanks to using buffer memory areas, decryption and decompression of the digital content can be effected in parts and in parallel. Accordingly, as soon as a part of the digital content M″ has been decrypted, it is stored in the first buffer memory area 312, where it can then be decompressed by the program 314, which stores the result of decompression in the second buffer memory area 313.

Note that, thanks to encryption by means of the key K1 and securing the session by means of the key K3, the digital content is always exchanged between the smart card 320 and the reproduction device in encrypted form or, in other words, by means of secure links between the smart card and the reproduction device.

FIG. 3 shows the main steps of the operation of the part of the reproduction device dedicated to reproducing the digital content from data stored in the second buffer memory area 313 (i.e. from decrypted and decompressed data); in the FIG. 1 example, this part of the device dedicated to reproduction is the audio reproduction circuit 330.

Strictly speaking, the reproduction process begins with the exchange of a session key K4 between the smart card (step E202) and the security circuit 331 (step E220). This session key exchange can be effected by the method proposed above for the session key K3 and described later with reference to FIG. 4.

Similarly, the session key K4 can be exchanged as soon as the reproduction device is switched on.

The smart card then proceeds in a step E204 to encrypt the identifier Id (which is part of the electronic license received from the issuing center as described above), by means of the session key K4, in order to obtain the identifier in encrypted form Id'.

The encrypted identifier Id' is then sent from the smart card 320 (step E206) to the security circuit 331 (step E222) via the reader 350 and the bus 305 which, thanks to the session key K4, form a secure link for sending the identifier.

The security circuit 331 can then decrypt the encrypted identifier Id' using the session key K4 in order to retrieve the identifier Id of the digital content (here the tune) M in a step E224.

The security circuit 331 also reads the decrypted and decompressed content in the second buffer memory area 313 and searches that content for a digital watermark in a step E226.

If no digital watermark is detected, the step E227 of verifying the presence of a watermark goes directly to the step E232 described below. This occurs, for example, if a part of the digital content can be reproduced without any authorization being necessary.

On the other hand, if a watermark is detected, the step E227 leads to a step E228 of comparing the detected watermark and the identifier Id of the tune. This comparison can for example consist in verification of the equality of the detected watermark and the identifier. Alternatively, another type of comparison could be used, for example comparing the detected watermark with the result of applying a hashing function to the identifier.

In all cases, and as already indicated, the digital watermark is imperceptible and robust, so that it is not possible for an external hacker (who does not know the extraction method used or the secret key that it uses) to obtain access to the identifier Id.

If the result of the comparison is negative, the reproduction process is stopped in a step E230, and so the device does not reproduce the digital content.

On the other hand, if the comparison result is positive, the step E228 leads to the step E232 in which the security device 331 sends the data previously read in the second buffer memory area 313 to the digital-to-analog converter 333 which leads to reproduction of the content by the sound reproducing means 332.

As before, the processing described with reference to FIG. 3 is preferably applied to only a part of the digital content and resumes after the step E232 at the step E226 of detecting a watermark in the content stored in the second buffer memory area 313. Thus the digital watermark is present periodically in the content, for periodically verifying the conformity of the content and the license rights (represented by the identifier Id) and to terminate reproduction if non-conformance is found.

An example of the method of exchanging a session key between the smart card and the reproduction device is described next with reference to FIG. 4. This example is explained in the context of exchanging the session key K3 (steps E106 and E128 described above), but it also applies, as already indicated, to the session key K4 (steps E202 and E220 described above).

According to this solution, the smart card holds a cryptography key K_{S} associated with the card itself, for example, or with a set of cards adapted to cooperate with the device, whereas the reproduction device holds a clean cryptography key K_{HW} and its certificate K′, which is equal to the key K_{HW} encrypted by means of the key K_{S}.

For example, the AES algorithm in CBC mode is used as the encryption algorithm in the FIG. 4 method.

Then in a step E400 the reproduction device draws a random (or pseudorandom) number A′.

It then proceeds in a step E402 to encrypt the number A′ by means of the key K_{HW} to obtain a number A″.

The reproduction device then sends the values A′ and K′ to the smart card in a step E406.

The smart card receives these values in a step E408.

It then proceeds in a step E410 to decrypt the encrypted key K′ by means of the key K_{S} in order to determine the cryptographic key K_{HW}, and to decrypt the value A″ by means of the key K_{HW} in a step E412 in order to recover the random number A′.

The smart card then proceeds in a step E414 to draw a random (or pseudorandom) number K3 which will later be used as a session key but of which the reproduction device as yet has no knowledge (step E414).

The smart card then calculates in a step E416 the product of applying the exclusive-OR (XOR) operator to the session key K3 and the random number A′, in order to obtain a value K3′(step E416) which is then encrypted by means of the key K_{HW} to obtain a number K3″ (step E418).

This number K3″ can be sent during a step E420 to the reproduction device, which receives it (step E422).

The reproduction device, which is assumed to know the key K_{HW}, can decrypt the number K3″ to retrieve the number K3′ (step E424), enabling the session key K3 to be found (step E426) by means of an exclusive-OR (XOR) operation between K3′ and A′.

Both entities therefore acquire knowledge of the session key K3 by exchanges that give no indication of it to malicious third parties.

The embodiment that has just been described represents only one possible embodiment of the invention. For example, with regard to exchanging a session key, the session key used can be derived from the random number K3 obtained in the step E414 thanks to a function shared by the smart card and the reproduction device.

1-45. (canceled)

46. Device for reproducing a digital content, characterized by:
means (331) for receiving an identifier (Id) of the digital content (M) from a secure electronic entity (320);
means (331) for extracting a digital watermark from the content (M);
means (331) for controlling the reproduction of the content (M) as a function of a comparison based on the extracted watermark and the identifier (Id).

47. Device according to claim 46, characterized in that the means (331) for receiving the identifier of the digital content include means (331, K4) for setting up a secure call with the secure electronic entity (320).

48. Device according to claim 46, characterized by means (311, K3) adapted to use a session key (K3) to decrypt an encrypted version (M″) of the digital content (M) received from the secure electronic entity (320).

49. Device according to claim 46, characterized by means (311, 350) for sending the encrypted digital content (M′) to the secure electronic entity (320).

50. Device according to claim 46, characterized by decompression means including decompression software (314) for obtaining the digital content from a compressed version (M) of the digital content.

51. Device according to claim 46, characterized in that the means for controlling reproduction of the content are adapted to command reproduction of the content in the event of equality between data obtained respectively from the extracted watermark and from the identifier (Id).

52. Device according to claim 46, further comprising means (311, 340) for receiving the identifier (Id) of a remote server and means (311, 350) for sending the identifier (Id) to the secure electronic entity (320), and the identifier (Id) is encrypted and adapted to be decrypted by means of a key (K5) stored in the secure electronic entity (320).

53. Device according to claim 46, characterized in that the reproduction device is a mobile telephone, and the secure electronic entity is a smart card (320) for managing the rights of the mobile telephone to access a telecommunication network.

54. Secure electronic entity adapted to cooperate with a device for reproducing a digital content, characterized by means for sending an identifier (Id) of the digital content to the reproduction device.

55. Electronic entity according to claim 54, characterized in that the means for sending the identifier of the digital content (Id) include means (K4) for setting up a secure call with the reproduction device.

56. Electronic entity according to claim 54, characterized by means (K3) for encrypting the digital content for transmission to the reproduction device.

57. Electronic entity according to claim 54, characterized by means (K1) for decrypting an encrypted version (M′) of the digital content (M) received from the reproduction device.

58. Electronic entity according to claim 54, characterized by means for decrypting an encrypted version of the identifier (Id) by means of a cryptography key (K5).

59. System comprising a device according to claim 46 and an electronic entity adapted to cooperate with a device for reproducing a digital content, characterized by means for sending an identifier (Id) of the digital content to the reproduction device.

60. Method of reproducing a digital content, characterized by the following steps:
receiving (E222) an identifier (Id') of the digital content (M) from a secure electronic entity (320);
extracting (E226) a digital watermark from the content (m);
commanding (E232) reproduction of the content (M) as a function of a comparison based on the extracted watermark and the identifier (Id).
